(19) United States
(12) Patent Application Publication
(10) Pub. No.: US 2026/0074759 A1
(43) Pub. Date: Mar. 12, 2026

(54) CSI REPORT STARTING LOCATION AND WINDOW CONFIGURATION FOR HIGH DOPPLER CSI

(71) Applicant: QUALCOMM Incorporated, San Diego, CA (US)

(72) Inventors: Liangming WU, Beijing (CN); Jing DAI, Beijing (CN); Wei XI, Beijing (CN); Min HUANG, Beijing (CN); Hao XU, Beijing (CN)

(21) Appl. No.: 19/109,501

(22) PCT Filed: Oct. 10, 2022
(86) PCT No.: PCT/CN2022/124283

§ 371 Date: Mar. 6, 2025

(51) Int. Cl. H04B 7/06; H04W 72/232

(52) U.S. Cl. CPC H04B 7/0626; H04B 7/0639; H04W 72/232

(57) ABSTRACT

Apparatuses and methods for CSI report starting location and window configuration are described. An apparatus is configured to receive information associated with a time window, which includes at least an offset from a start location and a window size, for a CSI report. The apparatus is configured to transmit the CSI report at the offset from the start location and for the window size of the time window. The CSI report includes CSI for a codebook refinement. Another apparatus is configured to transmit information associated with a time window, which includes at least an offset from a start location and a window size, for a CSI report. The other apparatus is configured to receive the CSI report at the offset from the start location and for the window size of the time window The CSI report includes CSI for a codebook refinement.

### TECHNICAL FIELD

The present disclosure relates generally to communication systems, and more particularly, to wireless communications utilizing channel status information (CSI) reporting.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to receive, from a network entity, information associated with a time window for a channel status information (CSI) report, where the time window includes at least an offset from a start location and a window size, for the CSI report. The apparatus is also configured to transmit, to the network entity, the CSI report associated with the offset from the start location and for the window size of the time window, where the CSI report includes CSI for a codebook refinement.

In the aspect, the method includes receiving, from a network entity, information associated with a time window for a channel status information (CSI) report, where the time window includes at least an offset from a start location and a window size, for the CSI report. The method also includes transmitting, to the network entity, the CSI report associated with the offset from the start location and for the window size of the time window, where the CSI report includes CSI for a codebook refinement.

In another aspect of the disclosure, a method, a computer-readable medium, and an apparatus are provided. The apparatus is configured to transmit, for a user equipment (UE), information associated with a time window for a channel status information (CSI) report, where the time window includes at least an offset from a start location and a window size, for the CSI report. The apparatus is also configured to receive, from the UE, the CSI report associated with the offset from the start location and for the window size of the time window, where the CSI report includes CSI for a codebook refinement.

In the other aspect, the method includes transmitting, for a user equipment (UE), information associated with a time window for a channel status information (CSI) report, where the time window includes at least an offset from a start location and a window size, for the CSI report. The method also includes receiving, from the UE, the CSI report associated with the offset from the start location and for the window size of the time window, where the CSI report includes CSI for a codebook refinement.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of channel status information (CSI) observation and prediction boundaries, in accordance with various aspects of the present disclosure.

FIG. 5 is a diagram illustrating an example of CSI windows, in accordance with various aspects of the present disclosure.

FIG. 6 is a diagram illustrating an example of a CSI reporting window, in accordance with various aspects of the present disclosure.

FIG. 7 is a call flow diagram for wireless communications, in accordance with various aspects of the present disclosure.

FIG. 8 is a diagram illustrating examples of CSI reporting configurations, in accordance with various aspects of the present disclosure.

FIG. 9 is a diagram illustrating examples of CSI reporting configurations, in accordance with various aspects of the present disclosure.

FIG. 10 is a diagram illustrating examples of CSI reporting configurations, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a diagram illustrating an example of a hardware implementation for an example apparatus and/or network entity.

FIG. 14 is a diagram illustrating an example of a hardware implementation for an example network entity.

### DETAILED DESCRIPTION

Various aspects herein relate to configurations for CSI report starting locations and CSI window configurations, such as for high doppler CSI. Some types of wireless communications (e.g., 5G NR) may be designed to enable CSI reporting, but utilize CSI configurations that limit scheduling flexibility generally, and also for UE mobility considerations. In addition, information at the UE side for CSI reporting may be underutilized, which may have impacts for resources at both the network side and UE side. The described aspects provide flexibility in configurations for start offsets and CSI window sizes that account for UE mobility and that provide higher data rates, higher capacity, and higher spectral efficiency for CSI measurements and reporting.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors i microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

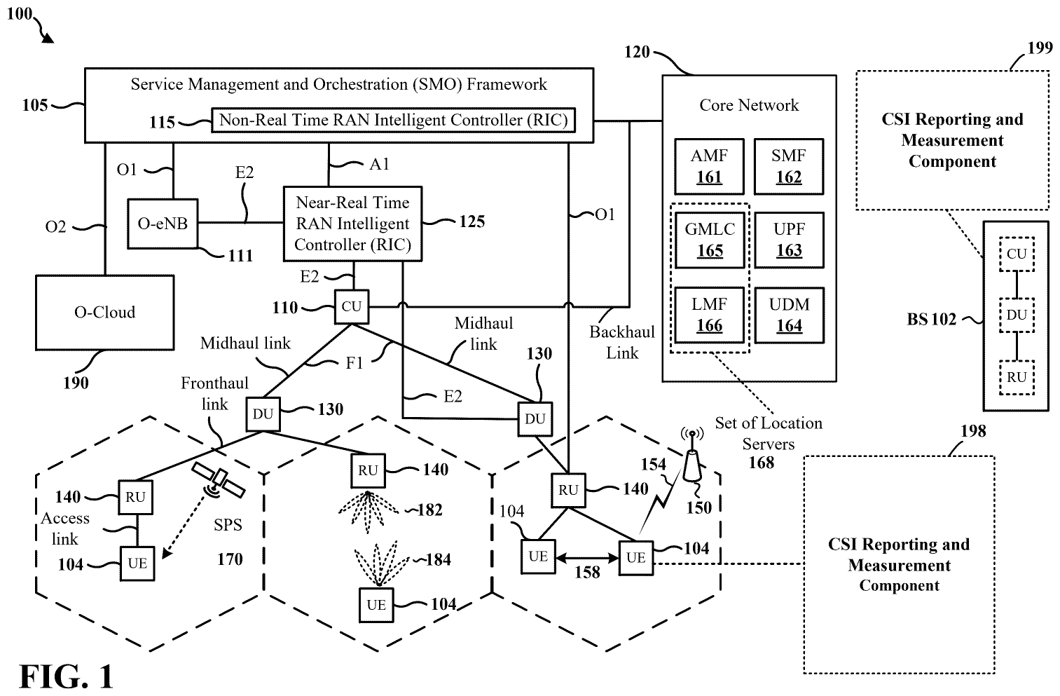

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a CSI reporting and measuring component 198 (“component 198”) that is configured to receive, from a network entity, information associated with a time window for a channel status information (CSI) report, where the time window includes at least an offset from a start location and a window size, for the CSI report. The the component 198 is also configured to transmit, to the network entity, the CSI report associated with the offset from the start location and for the window size of the time window, where the CSI report includes CSI for a codebook refinement. In some aspects, to receive the information, the component 198 may be configured to receive an RRC configuration of multiple offset-window size pairs, and to receive, in a medium access control (MAC) control element (MAC-CE) or a downlink (DL) control information (DCI), an indication of an offset-window size pair, from the multiple offset-window size pairs in the RRC configuration, to be the offset and the window size. In some aspects, to receive the information, the component 198 may be configured to receive an RRC configuration of multiple offsets and the window size, and to receive, in the MAC-CE or the DCI, an offset indication, from the multiple offsets in the RRC configuration, to be the offset. In some aspects, the component 198 may be configured to receive, from the network entity, at the offset from the start location and during the time window that has the window size, communications with a precoding that is based on the CSI report that includes the CSI for the codebook refinement. In certain aspects, the base station 102 may include a CSI reporting and measuring component 199 (“component 199”) that is configured to transmit, for a user equipment (UE), information associated with a time window for a channel status information (CSI) report, where the time window includes at least an offset from a start location and a window size, for the CSI report. The component 199 is also configured to receive, from the UE, the CSI report associated with the offset from the start location and for the window size of the time window, where the CSI report includes CSI for a codebook refinement. In some aspects, to transmit the information, the component 199 may be configured to transmit an RRC configuration of multiple offset-window size pairs, and to transmit, in the MAC-CE or the DCI, an indication of an offset-window size pair, from the multiple offset-window size pairs in the RRC configuration, to be the offset and the window size. In some aspects, to transmit the information, the component 199 may be configured to transmit an RRC configuration of multiple offsets and the window size, and to transmit, in the MAC-CE or the DCI, an offset indication, from the multiple offsets in the RRC configuration, to be the offset. In some aspects, the component 199 may be configured to transmitting, for the UE, at the offset from the start location and during the time window that has the window size, communications with a precoding that is based on the CSI report that includes the CSI for the codebook refinement. Although the following description may be focused on 5G NR, the concepts described herein may be applicable to other similar areas, such as LTE, LTE-A, CDMA, GSM, and other wireless technologies. In addition, while the following description may be focused on UE-side prediction of channel/CSI, the concepts herein may also be applicable to network-side prediction.

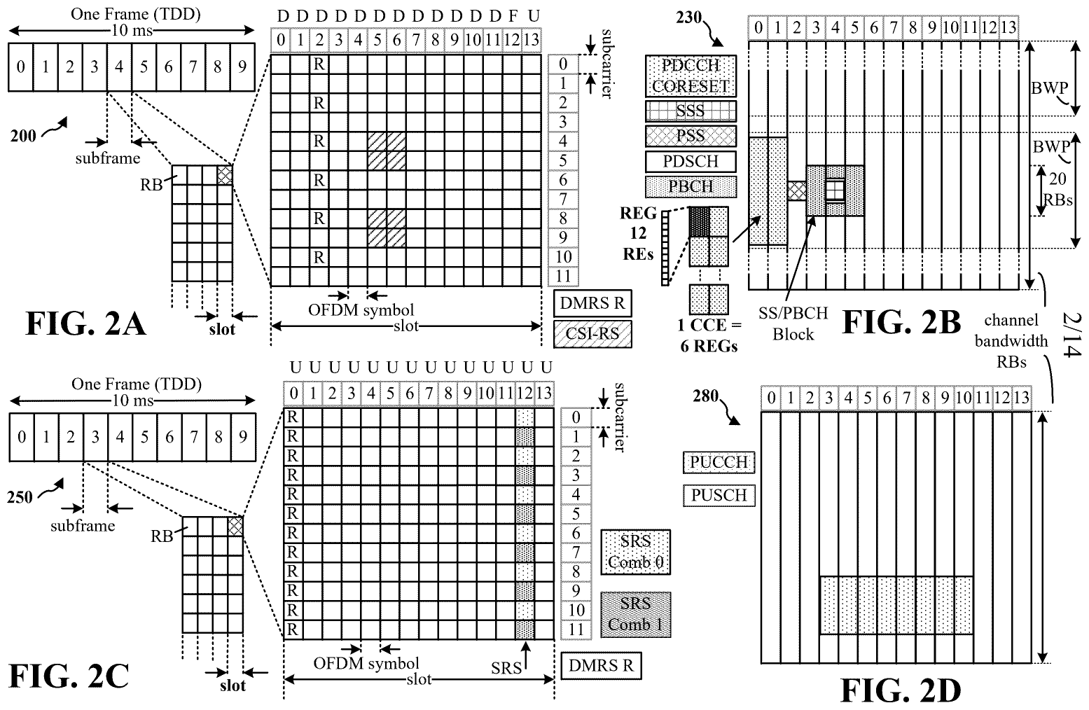

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δƒ = 2μ · 15 [KHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology p=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

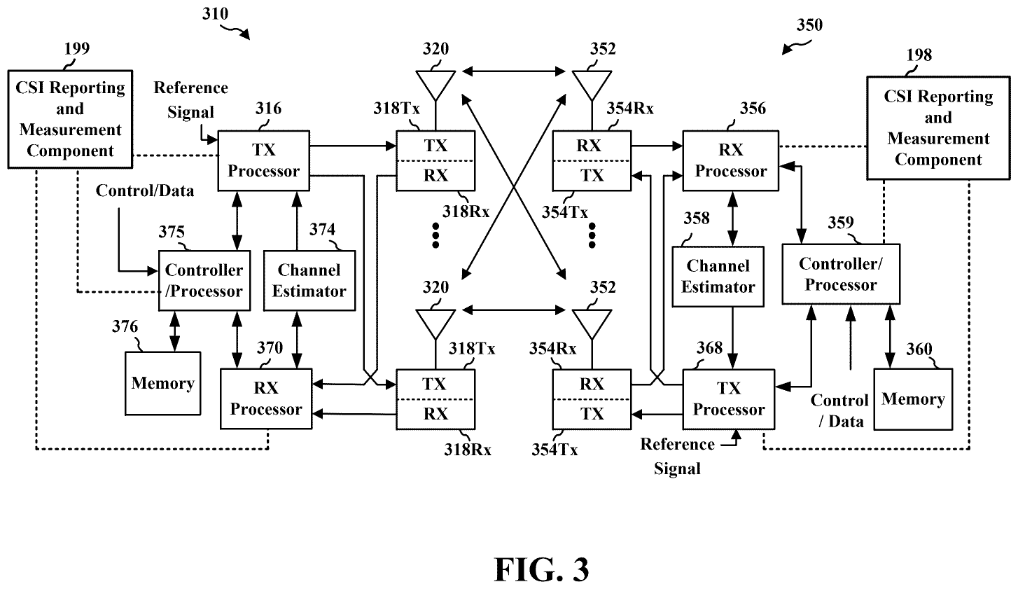

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the CSI reporting and measuring component 198 of FIG. 1. At least one of the TX processor 316, the RX processor 370, and the controller/processor 375 may be configured to perform aspects in connection with the CSI reporting and measuring component 199 of FIG. 1.

Some types of wireless communications (e.g., 5G NR) may be designed to enable CSI reporting, but utilize CSI configurations that limit scheduling flexibility generally and also for UE mobility considerations. Relatedly, information at the UE side for CSI reporting may be underutilized, which may have impacts on resources at both the network- and UE-sides.

Aspects presented herein may provide enhancements to support improved CSI reporting. Aspects presented herein may include, without limitation, configurations for start offsets and CSI window sizes that provide scheduling flexibility, utilize UE-side measurements, and account for UE mobility, such as medium-/high-velocity (e.g., Type-II Doppler), which enables specific codebook refinements by network entities. Additionally, the aspects presented provide for higher data rates, higher capacity, and higher spectral efficiency for CSI reporting and measurements. For instance, a UE may receive information associated with a time window (e.g., having an offset from a start location and a window size) for a CSI report from a network entity. The received information may be for, or be related to, configuring of the offset from the start location and/or configuring of the window size for the CSI report. The described aspects enable the UE to transmit CSI for a codebook refinement in the CSI report, where the CSI report is associated with the offset from the start location and is for the window size of the time window.

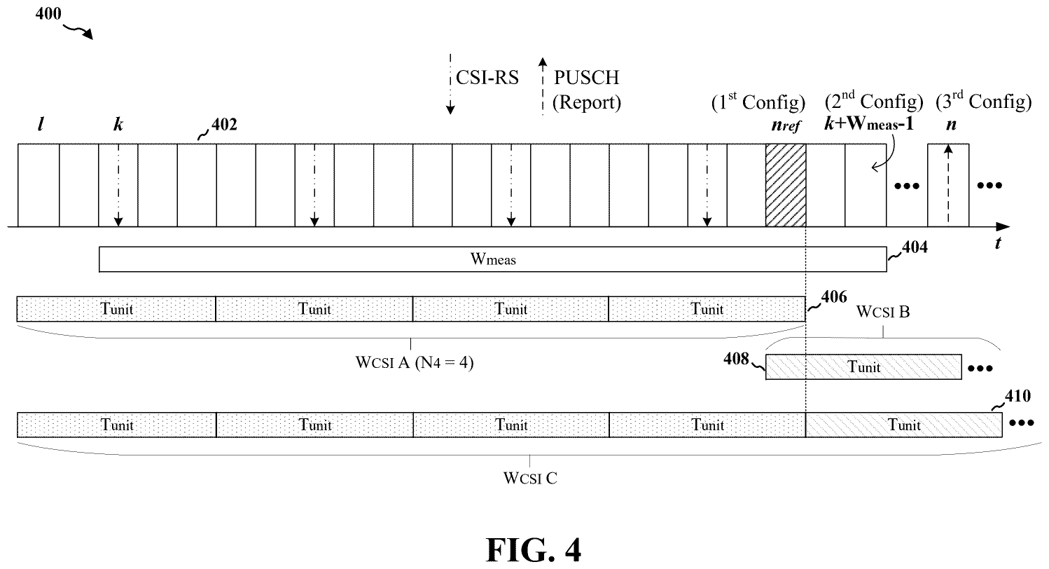

FIG. 4 is a diagram 400 illustrating an example of CSI observation and prediction boundaries, in various aspects. Diagram 400 includes slots 402 shown with respect to time, a measurement window 404, and different window sizes (WCSI) of the overall CSI window, shown as a window size 406 (WCSI A), a window size 408 (WCSI B), and a window size 410 (WCSI C).

In aspects for CSI reporting and measurement for codebook refinement for high-/medium-velocities, UE-side prediction may be utilized, and down-selecting may be performed for one from the following alternatives: a UE predicting channel/CSI after a slot n_{ref} with a reference resource, a UE predicting channel/CSI after a slot n where the CSI is reported, etc. In aspects for CSI reporting and measurement for codebook refinement for high-/medium-velocities, where UE-side prediction may be utilized, down-selecting may be performed for one from the following alternatives: a slot index ‘l’ that is greater than or equal to n_{ref} (where n_{ref}, a CSI reference resource slot, and may be a boundary), a slot index/that is greater than or equal to n (where n is a report slot, and may be a boundary), etc.

With reference to diagram 400 of FIG. 4 and slots 402, a CSI report is shown for slot n, and a length of the DD/TD basis vector is shown as N4 (where the basis vector may have a length but no span/window in the time-domain). As described and referred to herein, N4 may be the designator/name given to a length for a reporting window for CSI. Measurement window 404, a CSI-RS measurement window in the illustrated aspect, may have a length/size of [k, k+Wmeas−1] representing the window in which a CSI-RS occasion(s) are measured for calculating a CSI report, where k may be a slot index and Wmeas may be the measurement window length (e.g., in slots). A CSI reporting window may have a length/size of [l,l+WCSI−1] and may be associated with the CSI report in slot n (e.g., transmitted via PUSCH), where l may be a slot index and WCSI may be the reporting window length (in slots). It should be noted that CSI may reference a resource(s) in the time domain, and the location of a CSI reference resource may be denoted as n_{ref} (slot index).

In the context of down-selections for specific configurations, various aspects are now described. In a first configuration, the slot for n_{ref} (e.g., the CSI reference resource slot) may be used as a boundary. In such a configuration, various aspects may provide for:

$$( a ) : l + {W}_{CSI} - 1 \leq {n}_{ref} ;$$

$$( b ) : l \geq {n}_{ref} ; and / or$$

$$( c ) : l < {n}_{ref} , and l + {W}_{CSI} - 1 > {n}_{ref} .$$

In a second configuration, the slot for n (e.g., the report slot) may be used as a boundary. In such a configuration, various aspects may provide for:

$$( a ) : l + {W}_{CSI} - 1 \leq n ;$$

$$( b ) : l \geq n ; and / or$$

$$( c ) : l < n , and l + {W}_{CSI} - 1 > n .$$

In a third configuration, the end slot of Wmeas (e.g., k+Wmeas−1) may be used as a boundary. In such a configuration, various aspects may provide for:

$$( a ) : l + {W}_{CSI} - 1 \leq k + Wmeas - 1 ( with a special case : l = k , {W}_{CSI} = Wmeas ) ;$$

$$( b ) : l \geq k + Wmeas - 1 ; and / or$$

$$( c ) : l < k + Wmeas - 1 , and l + {W}_{CSI} - 1 > k + Wmeas - 1 ( with special cases : l = k , l + {W}_{CSI} = n ; and / or l = k , l + {W}_{CSI} > n ) .$$

In the configurations described above for diagram 400, the first, second, and third configurations may differentiate which slot may be the boundary of past/observation and future/prediction. It should also be noted that (a) for the first, second, and third configurations may be for observation-only, that (b) for the first, second, and third configurations may be for prediction-only, and that (c) the first, second, and third configurations may be for observation and prediction.

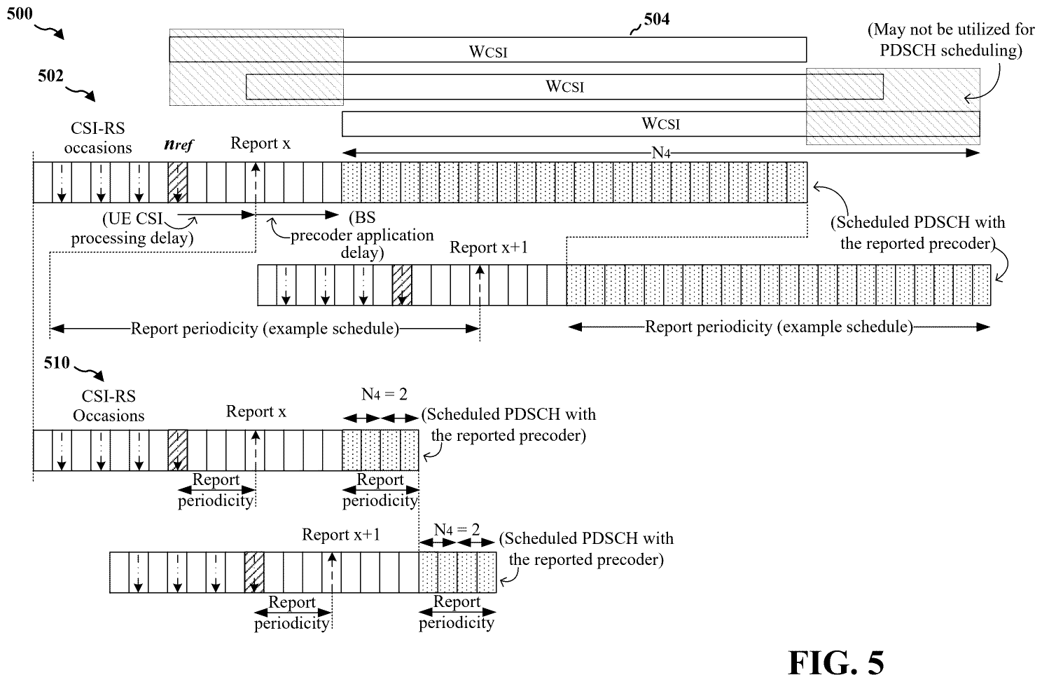

FIG. 5 is a diagram 500 illustrating an example of CSI windows, in various aspects. Diagram 500 may be a further aspect of diagram 400 in FIG. 4. Diagram 500 illustrates a configuration 502 for a CSI window and a configuration 510 for a CSI window, each shown as slots with respect to time.

The configuration 502, as illustrated, includes example time windows 504, having a window size WCSI of N4, spanning many slots, and respective offsets (L) not shown for illustrative clarity. As similarly described above for diagram 400 in FIG. 4, CSI-RS occasions (e.g., CSI-RS received by a UE from a network entity, such a base station or a portion thereof) that occur in slots up to the slot for n_{ref} (e.g., the CSI reference resource slot). In aspects, the CSI-RS may be counted and/or measured by the UE, and following a delay for UE processing to generate a CSI report (Report x), the CSI report may be transmitted (e.g., via PUSCH) to the network entity. The network entity may apply a precoding based on a precoder reported in the CSI report, after which the network entity may transmit scheduled DL communications (e.g., via PDSCH) with the applied precoding. The configuration 502 also shows a subsequent CSI report (Report x+1) based on a similar process that may align with Report x as corresponding to a report periodicity (shown for an example schedule).

Likewise, the configuration 510, as illustrated, includes CSI-RS occasions (e.g., CSI-RS received by a UE from a network entity, such a base station or a portion thereof) that occur in slots up to the slot for n_{ref}, as in the configuration 502, where in aspects, the CSI-RS may be counted and/or measured by the UE, and following a delay for UE processing to generate a CSI report (Report x), the CSI report may be transmitted (e.g., via PUSCH) to the network entity, as in the configuration 502. The network entity may apply a precoding based on a precoder reported in the CSI report, after which the network entity may transmit scheduled DL communications (e.g., via PDSCH) with the applied precoding. The configuration 502 also shows a subsequent CSI report (Report x+1) based on a similar process that may align with Report x in the configuration 510 as corresponding to a report periodicity. However, the illustrated window size WCSI in the configuration 510 is shown as N4=2, which is a smaller window size WCSI in the configuration 510 than the N4 in the configuration 502.

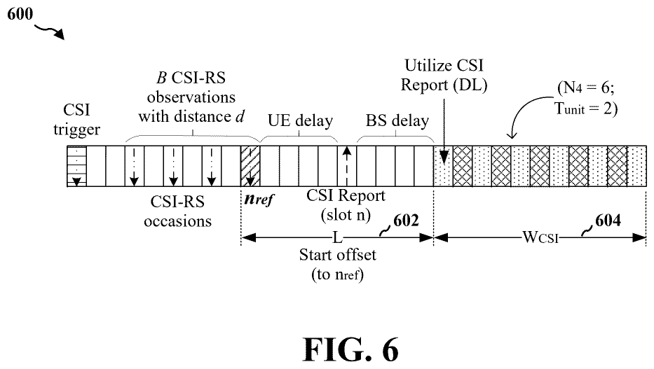

FIG. 6 is a diagram 600 illustrating an example of a CSI reporting window, in various aspects. Diagram 600 is also shown as slots with respect to time and includes a time window for a CSI report that may be based on a start offset 602 (L), which may be an offset with respect to the slot for n_{ref}, and a window size 604 (WCSI), which may be based at least in part on N4 and/or a Tᵤₙᵢₜ parameter and during which a network entity (e.g., a base station or component of a base station) may transmit DL information (e.g., via PDSCH) utilizing the CSI report (e.g., via codebook refinement). In aspects, window size (WCSI) may be the product of N4 and Tᵤₙᵢₜ (e.g., a granularity of time slots for the CSI report). As an illustrative example, diagram 600 shows N4=6 and Tᵤₙᵢₜ=2.

In aspects, the start offset 602 (L) and/or the window size 604 (WCSI) may be configured in various ways/layers, jointly and/or separately (e.g., RRC, MAC-CE, DCI, etc.; which may be hierarchically configured via down-selections) based on information associated with, and/or based on, a CSI/DL trigger, a number B of CSI-RS observations and/or a distance d of the CSI-RS observations, the slot for n_{ref} (a CSI reference slot), the CSI report slot n, and/or the like, as are described in the example aspects below and as shown in their associated Figures. In one example, the start location may be a slot l≥n_{ref} (e.g., the CSI reference resource slot, which may be used as a boundary), as illustrated in diagram 600; while in another example, the start location may be a slot l≥n (e.g., the CSI report slot, which may be used as a boundary).

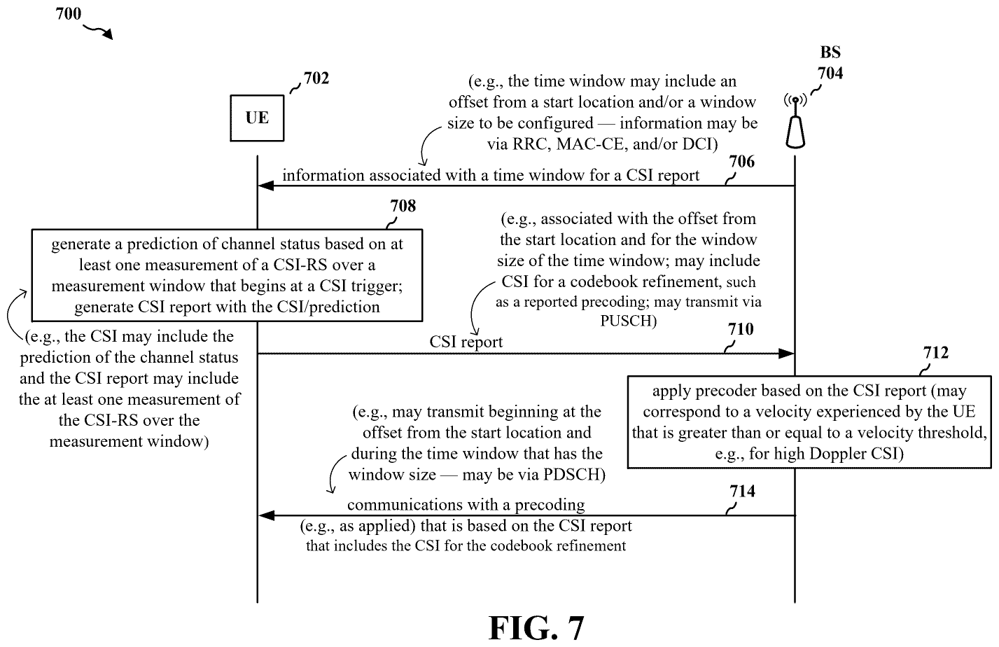

FIG. 7 is a call flow diagram 700 for wireless communications, in various aspects. Call flow diagram 700 illustrates CSI report starting location and window configuration, e.g., for high doppler CSI, according to aspects.

In the illustrated aspect, a UE 702 transmits, to a network node (e.g., a BS 704, such as a gNB, as shown, or one or more components of a base station), information 706 associated with a time window for a CSI report 710, e.g., to be transmitted by the UE 702. In aspects, the information 706 may include information associated with the offset from the start location and/or the window size from which the offset and/or the window size may be identified, derived, calculated, and/or the like, for configuration thereof, while in other aspects, the information 706 may include values, e.g., via configuration, for the offset from the start location and/or the window size.

In aspects, the information 706 received by the UE 702 and transmitted by the base station 704 may be, without limitation, communicated via RRC, MAC-CE, DCI, and/or the like, for configuration of the CSI report 710. In aspects, information 706 may be received by the UE 702 and transmitted by the base station 704 as one or more communications that may be jointly, or separately (e.g., hierarchically with down-selection), communicated to/at the UE 702. In aspects, the information 706 may include, without limitation, an offset (e.g., L) from a start location and/or a window size (e.g., N4), associated with the time window for the CSI report 710, to be configured. In aspects, receiving the information 706 may include receiving the offset from the start location and the window size separately via RRC. In aspects, receiving the information 706 may include receiving an RRC configuration of multiple offset-window size pairs, and receiving, in a MAC-CE or a DCI, an indication of an offset-window size pair, from the multiple offset-window size pairs in the RRC configuration, to be the offset and the window size. In aspects, receiving the information 706 may include receiving an RRC configuration of multiple offset values and a window size value, and receiving, in a MAC-CE or a DCI, an indication of an offset value, from the multiple offset values in the RRC configuration, to be the offset along with previously-configured the window size. In aspects, the offset from the start location may correspond to a relative slot level offset to a DL trigger, a CSI reference slot, or a CSI report slot.

In aspects, the information 706 may include information associated with the offset from the start location and/or the window size from which the offset and/or the window size may be identified, derived, calculated, and/or the like, for configuration thereof. For example, the association between the window size and the pilot length may be a linear association that may be based on a product of the number of receptions of the CSI-RS at the UE 702 and a linear parameter that may be defined or that may be provided as part of the information 706, or may be a tabulated association in which the window size may correspond to a range of the number of receptions of the CSI-RS at the UE 702. In aspects, the information 706 may include a minimal value and/or a maximal value of the window size, and the CSI report 710 may include the window size that is based on a measurement(s) of a CSI-RS over a measurement window (e.g., a distance d or size Wmeas) at the UE 702, e.g., for configuration of the window size. In aspects, the information 706 may include an index value for a set of parameter combinations that may each include an associated window size and a frequency parameter(s). In such aspects, the associated window size of the parameter combination of the set of parameter combinations that correspond to the index value may be selected as the window size by the UE 702. In aspects, each parameter combination of the set of parameter combinations may also include a time domain basis parameter that corresponds to a respective associated window size.

In one configuration, the UE 702 may generate (at 708) a prediction of channel status that may be based on a measurement(s) of a CSI-RS over a measurement window that may begin at a CSI trigger, and the UE 702 may generate the CSI report 710 to include the CSI. In such a configuration, the CSI may include the prediction of the channel status, and the CSI report 710 may include the measurement(s) of the CSI-RS over the measurement window. That is, the CSI may include the prediction of the channel status at the UE 702, e.g., by the UE 702, and the CSI report 710 may include the measurement(s) of the CSI-RS over the measurement window at the UE 702. In aspects, the window size may be included in the CSI report 710 as a parameter in PMI information. In aspects, the generation of the CSI report 710 may be associated with a processing delay at the UE 702.

The CSI report 710 that is generated by the UE (e.g., at 708) may be transmitted to the base station 704, for application of a precoder included in the CSI report 710. The base station 704 may apply (at 712) the reported precoder, e.g., for codebook refinement, based on the CSI report, which may correspond to a velocity experienced by the UE that is greater than or equal to a velocity threshold, e.g., for high Doppler CSI. In aspects, the application of the precoder may be associated with an application delay at the base station 704.

Subsequent to application of the precoder (at 712), communications 714 with a precoding (e.g., as applied) that may be based on the CSI report (which may include the CSI for the codebook refinement) may be transmitted by the base station 704 and received by the UE 702. The UE 702 may thus receive, from the network entity, at the offset from the start location and during the time window that has the window size, the communications 714 with the applied precoding that may be based on the CSI report 710 that may include the CSI for the codebook refinement. The communications 714 may be transmitted by the base station 704 and received by the UE 702 beginning at the offset from the start location and during the time window that has the window size. In aspects, the communications 714 may be via PDSCH, and/or the like.

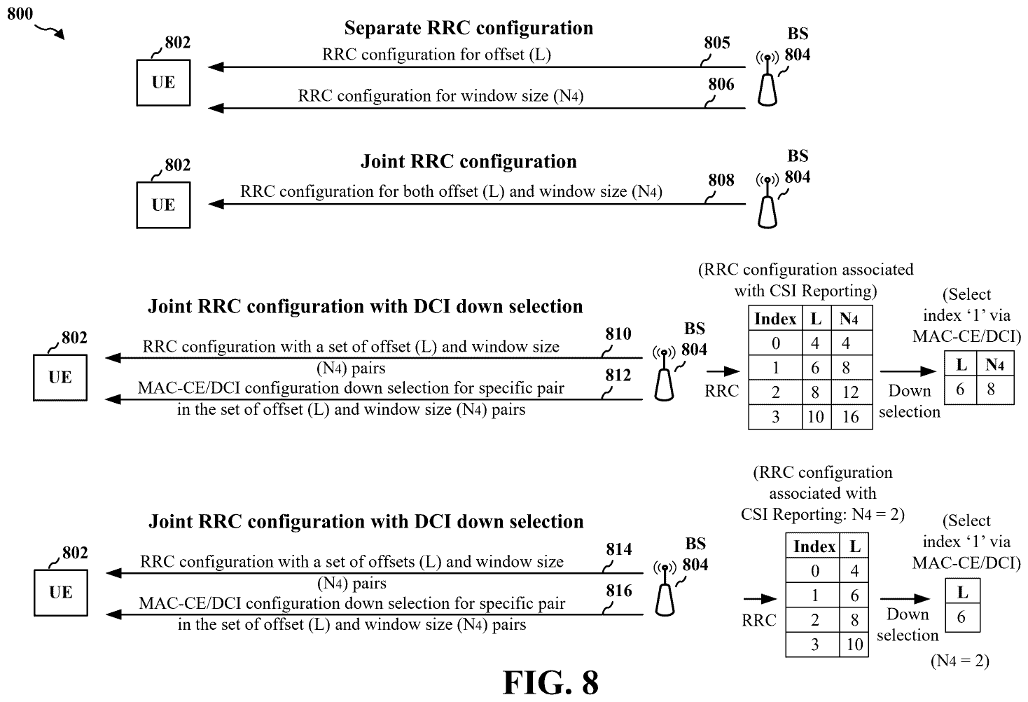

FIGS. 8, 9, 10 are now described below, in the context of FIGS. 6, 7 as described above.

FIG. 8 is a diagram 800 illustrating examples of CSI reporting configurations, in accordance with various aspects of the present disclosure. Diagram 800 includes a UE 802 and a base station 804. In aspects, the UE 802 and the base station 804 may be configured to perform offset (L) from a start location and window size (N4) configurations as described herein, e.g., with respect to FIGS. 6, 7. For example, an offset (L) from the start location and a window size (N4) may be separately or jointly configured in DL signaling. In aspects, the offset (L) from the start location may be defined as a relative slot level offset to PDSCH triggering (CSI trigger), CSI reference slot (n_{ref}), CSI report slot, etc., as illustrated by way of example in FIG. 6.

In one configuration, e.g., for separate RRC configuration, a configuration 805 may be transmitted from the base station 804 and received by the UE 802 with a value for the offset (L) from the start location. In the configuration, a configuration 806 may be transmitted from the base station 804 and received by the UE 802 with a value for the window size (N4). The configuration 805 and/or the configuration 806 may be comprised in DL signaling such an one or more RRC messages, as illustrated. In some aspects, any combination of RRC, MAC-CE, or DCI signaling may be utilized to provide the value for L and N4 to the UE 802.

In one configuration, e.g., for joint RRC configuration, a configuration 808 may be transmitted from the base station 804 and received by the UE 802 with a value for the offset (L) from the start location and with a value for the window size (N4). The configuration 808 may be comprised in DL signaling such as an RRC configuration, as illustrated. In some aspects, any combination of RRC, MAC-CE, or DCI signaling may be utilized to provide the value for L and N4 to the UE 802.

In some configurations, the configuring of the offset (L) from the start location and/or the window size (N4) may be performed hierarchically, e.g., via down-selection (joint RRC configuration of multiple values with down-selection or indication of a particular value in control signaling such as a MAC-CE or DCI).

In one such configuration, an RRC configuration 810 with a set of offset (L) and window size (N4) pairs may be transmitted from the base station 804 and received by the UE 802. That is, the base station may transmit RRC signaling to the UE to configure several candidate L and N4 pairs for the UE 802. Subsequently, a configuration 812, e.g., via MAC-CE or DCI, with a down selection for a specific pair in the set of offset (L) and window size (N4) pairs, may be transmitted from the base station 804 and received by the UE 802. That is, the MAC-CE or DCI may further down-select within the candidates configured, and designate/identify one of the pairs as the offset (L) and window size (N4) for the UE 802 to use for CSI reporting. As an example, this configuration is shown in diagram 800 with a set, or number, of L/N4 pairs, each associated with an index value. The indexed L/N4 pairs may be provided from the base station 804 to the UE 802 via RRC, and a subsequent MAC-CE/DCI may select an index value corresponding to a particular L/N4 pairs which may then be configured as the offset (L) and the window size (N4).

In another such configuration, an RRC configuration 814 with a set of offsets (L) and a window size (N4) may be transmitted from the base station 804 and received by the UE 802. That is, RRC signaling from the base station 804 may configure several candidate L values and a value for N4 (e.g., the L and N4 are separately configured in RRC signaling) for the UE. Subsequently, a configuration 816, e.g., via MAC-CE or DCI, with a down selection for a specific L value in the set of offsets (L), may be transmitted from the base station 804 and received by the UE 802. That is, the MAC-CE or DCI may further down-select within the L candidates configured, and designate/identify one of the values for the offset (L) (where the window size (N4) was previously configured via RRC). As an example, this configuration is shown in diagram 800 with a set, or number, of L values, each associated with an index value. The indexed L values may be provided from the base station 804 to the UE 802 via RRC, and a subsequent MAC-CE/DCI may select an index value corresponding to a particular L value, which may then be configured as the offset (L) associated with the previously-configured the window size (N4).

In aspects, the configurations of diagram 800 may be utilized by the UE 802 in generating and transmitting a CSI report (e.g., at 708; CSI report 710 of FIG. 7) for a codebook refinement (at 712) at the base station 804 and subsequent communications (e.g., communications 714) with the reported/applied precoding at the offset (L) from the start location and during the time window that has the window size (N4).

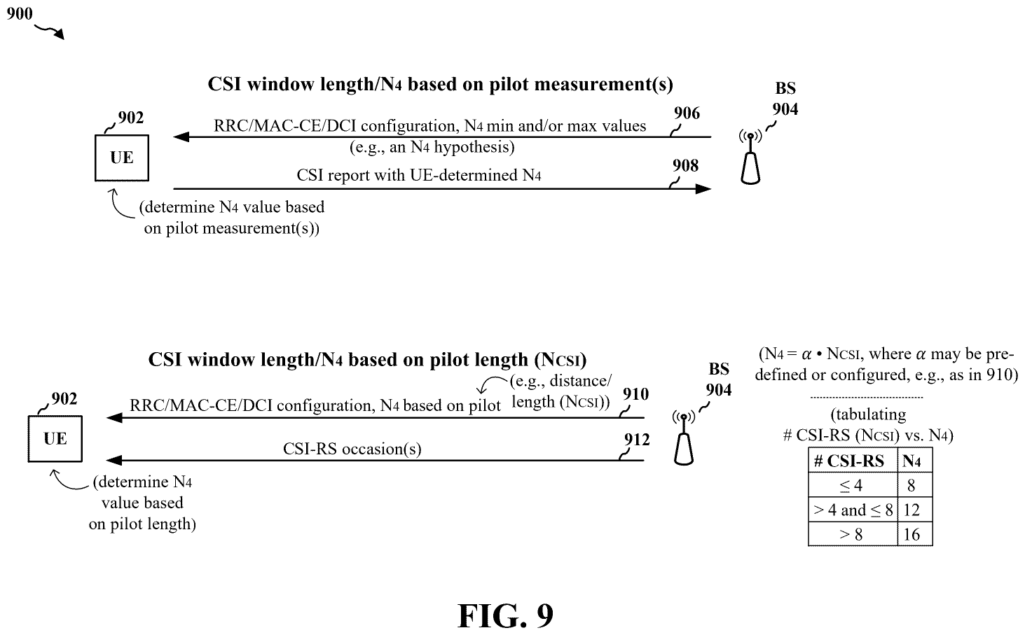

FIG. 9 is a diagram 900 illustrating examples of CSI reporting configurations, in accordance with various aspects of the present disclosure. Diagram 900 includes a UE 902 and a base station 904. In aspects, the UE 902 and the base station 904 may be configured to perform offset (L) from a start location and window size (N4) configurations as described herein, e.g., with respect to FIGS. 6, 7 (CSI window length/N4 configuration based on pilot/RS measurement(s)). For example, a CSI window length/size (N4) may be UE-reported. That is, a UE such as the UE 902, may be more knowledgeable about a velocity/Doppler experienced or observed by the UE 902, and thus aspects provide for the UE to determine the CSI report window length/size (N4) from within a set configured for the UE 902.

As shown in diagram 900, a configuration 906 may be transmitted from the base station 904 and received by the UE 902. The configuration 906 may include a minimal value and/or a maximal value of the window size (N4), e.g., an N4 hypothesis from the base station 904). The UE 902 may be configured to observe and measure the pilot/CSI-RS occasion (e.g., as in FIG. 6), and to determine its N4 value based on the observation(s)/measurement(s) and bounded by the minimal value and/or the maximal value of the window size (N4). The UE 902 may then transmit a CSI report 908 with the UE-determined value and/or a maximal value of the window size (N4) to the base station 904. In the configuration, the CSI report 908 may include the window size that may be based on at least one measurement of a CSI-RS (pilot) over the measurement window (Wmcas) at the UE 902. The window size (N4) may be included in the CSI report 908 as a parameter in precoding matrix indicator (PMI) information, in such configurations.

Diagram 900 also shows a configuration 910 that may be transmitted from the base station 904 and received by the UE 902. The configuration 910 may include an indication to configure the window size (N4) based on the CSI-RS (pilot) occurrences. For instance, more observed CSI-RSs/pilots may correlate to better capability for channel extrapolation by the UE 902/base station 904, and to larger windows. In aspects, the distance/length of the CSI-RS (d, number of occasions NCSI, etc.) may be the basis for association to determine the window size (N4) based on the CSI-RS/pilot. That is, the window size (N4) may be associated with a CSI-RS/pilot length that corresponds to a number of receptions of CSI-RS(s) at the UE 902 (e.g., N4 may be implicitly associated with the configured CSI-RS/pilot length). CSI-RS occasion(s) 912 may be transmitted from the base station 904 and received by the UE 902, and the UE 902 may observe/count the number CSI-RS occasion(s) 912. The UE 902 may then determine the window size (N4) based on the observations/counts for the configured CSI-RS/pilot length.

In aspects for the configuration 910, e.g., to configure the window size (N4) based on the CSI-RS (pilot) occurrences, the association between the window size (N4) and the CSI-RS/pilot) may be a linear association based on a product of the number of receptions of the CSI-RS at the UE 902 and a linear parameter that is defined, e.g., known, or that is provided as a part of the information, may be a tabulated association in which the window size corresponds to a range of the number of receptions of the CSI-RS at the UE 902, etc. For example, with respect to configuration 910 and a linear association, N4 may equal α·NCSI, where α may be defined, e.g., known, or configured by base station 904. In other aspects, with respect to configuration 910 and a tabular association, one example is shown as tabulated in diagram 900, where N4=8 when the CSI-RS (pilot) occurrences are ≤4, where N4=12 when the CSI-RS (pilot) occurrences are >4 and ≤8, and where N4=16 when the CSI-RS (pilot) occurrences are >8.

In aspects, the configurations of diagram 900 may be utilized by the UE 902 in generating and transmitting a CSI report (e.g., at 708; CSI report 710 of FIG. 7) for a codebook refinement (at 712) at the base station 904 and subsequent communications (e.g., communications 714) with the reported/applied precoding at the offset (L) from the start location and during the time window that has the window size (N4).

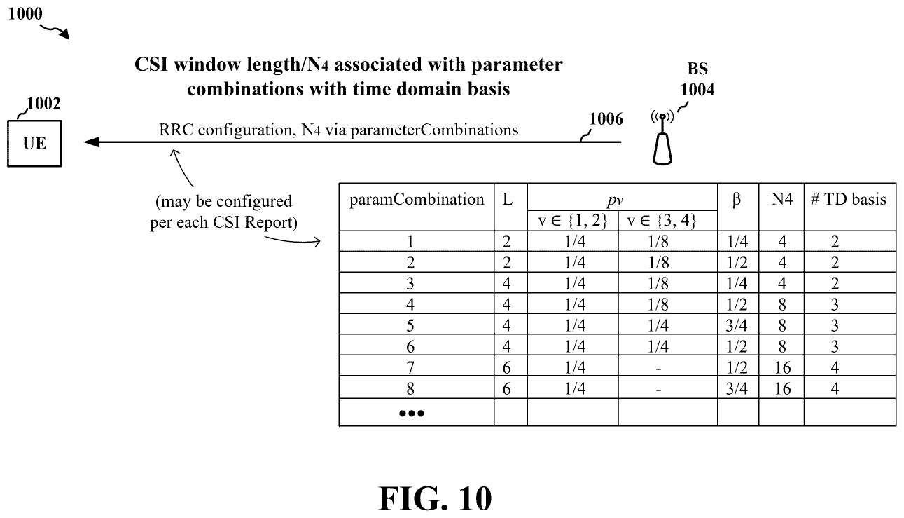

FIG. 10 is a diagram 1000 illustrating examples of CSI reporting configurations, in accordance with various aspects of the present disclosure. Diagram 1000 includes a UE 1002 and a base station 1004. In aspects, the UE 1002 and the base station 1004 may be configured to perform offset (L) from a start location and window size (N4) configurations as described herein, e.g., with respect to FIGS. 6, 7 (CSI window length/N4 as associated with parameter combinations (parameterCombination) with a time domain basis). For example, a CSI window length/size (N4) may be provided to a UE, such as the UE 902, as a parameter of a parameter combination.

Diagram 1000 illustrates a configuration 1006 that may be transmitted from the base station 1004 and received by the UE 1002. The configuration 1006 may include values/fields for a parameter combination index or identifier, an offset L, frequency domain layer information (pv) and B (e.g., where v indicates an element of a layer ({1, 2} and {3, 4}), window size (N4), and a number (3) of time domain (TD) basis, by way of example as shown. In aspects, each row of the parameterCombination information may indicate a value for the time window (N4), and the selection of the paramCombination may be performed via RRC configuration per CSI-report configuring.

In aspects, the configurations of diagram 1000 may be utilized by the UE 1002 in generating and transmitting a CSI report (e.g., at 708; CSI report 710 of FIG. 7) for a codebook refinement (at 712) at the base station 1004 and subsequent communications (e.g., communications 714) with the reported/applied precoding at the offset (L) from the start location and during the time window that has the window size (N4).

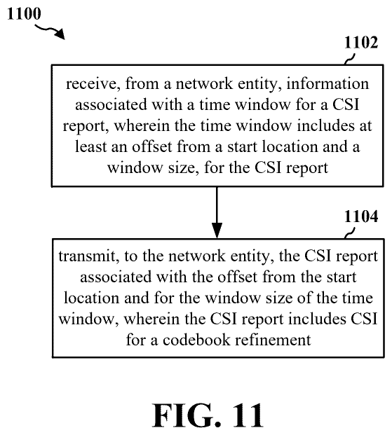

FIG. 11 is a flowchart 1100 of a method of wireless communication, in accordance with various aspects of the present disclosure. The method may be performed by a UE (e.g., the UE 104, 702, 802, 902, 1002; the apparatus 1304). At 1102, the UE receives, from a network entity, information associated with a time window for a CSI report, where the time window includes at least an offset from a start location and a window size, for the CSI report. In some aspects, 1102 may be performed by the component 198.

For example, referring to FIGS. 6-10, the UE 702 (802, 902, 1002) may receive, from a network node (e.g., the base station 704 (804, 904, 1004)), information 706 (805, 806, 808, 810, 812, 814, 816, 906, 910, 912, 1006) associated with a time window for a CSI report 710 to be transmitted by the UE 702 (802, 902, 1002). In aspects, the information 706 (906, 910) may include information associated with the offset (L) from the start location and/or the window size (N4) from which the offset (L) and/or the window size (N4) may be identified, derived, calculated, and/or the like, for configuration thereof, while in other aspects, the information 706 (805, 806, 808, 810, 812, 814, 816, 912, 1006) may include values, e.g., via configuration, for the offset (L) from the start location and/or the window size (N4). In aspects, the information 706 (805, 806, 808, 810, 812, 814, 816, 906, 910, 912, 1006) received by the UE 702 (802, 902, 1002) and transmitted by the base station 704 (804, 904, 1004) may be, without limitation, communicated via RRC, MAC-CE, DCI, and/or the like, for configuration of the CSI report 710. In aspects, information 706 (805, 806, 808, 810, 812, 814, 816) may be received by the UE 702 (802) and transmitted by the base station 704 (804) as one or more communications that may be jointly, or separately (e.g., hierarchically with down-selection), communicated to/at the UE 702 (802). In aspects, the information 706 (805, 806, 808, 810, 812, 814, 816) may include, without limitation, an offset (e.g., L) from a start location and/or a window size (N4), associated with the time window for the CSI report 710, to be configured. In aspects, receiving the information 706 (805, 806) may include receiving the offset (L) from the start location and the window size (N4) separately via RRC. In aspects, receiving the information 706 (810, 812) may include receiving an RRC configuration of multiple offset-window size pairs, and receiving, in a MAC-CE or a DCI, an indication of an offset-window size pair, from the multiple offset-window size pairs in the RRC configuration, to be the offset and the window size. In aspects, receiving the information 706 (814, 816) may include receiving an RRC configuration of multiple offset values (L) and a window size (N4) value, and receiving, in a MAC-CE or a DCI, an indication of an offset value (L), from the multiple offset values in the RRC configuration, to be the offset (L) along with previously-configured the window size (N4). In aspects, the offset from the start location may correspond to a relative slot level offset to a DL trigger, a CSI reference slot, or a CSI report slot (CSI trigger, n_{ref}, or n).

In aspects, the information 706 (906, 910, 912, 1006) may include information associated with the offset (L) from the start location and/or the window size (N4) from which the offset (L) and/or the window size (N4) may be identified, derived, calculated, and/or the like, for configuration thereof. For example, the association between the window size (N4) and the pilot length (NCSI, d) may be a linear association that may be based on a product of the number of receptions of the CSI-RS at the UE 702 (902) and a linear parameter (a) that may be defined or that may be provided as part of the information 706, or may be a tabulated association in which the window size (N4) may correspond to a range of the number of receptions of the CSI-RS at the UE 702 (902). In aspects, the information 706 (906) may include a minimal value and/or a maximal value of the window size (N4), and the CSI report 710 may include the window size (N4) that is based on a measurement(s) of a CSI-RS over a measurement window (e.g., a distance d or size Wmeas as in FIG. 6) at the UE 702 (902), e.g., for configuration of the window size (N4). In aspects, the information 706 (1006) may include an index value for a set of parameter combinations that may each include an associated window size (N4) and a frequency parameter(s). In such aspects, the associated window size (N4) of the parameter combination of the set of parameter combinations that correspond to the index value may be selected as the window size (N4) by the UE 702 (1002). In aspects, each parameter combination of the set of parameter combinations may also include a time domain basis parameter that corresponds to a respective associated window size (N4).

At 1104, the UE transmits, to the network entity, the CSI report associated with the offset from the start location and for the window size of the time window, where the CSI report includes CSI for a codebook refinement. In some aspects, 1104 may be performed by the component 198.

For example, referring to FIGS. 6-10, in one configuration, the CSI report 710 that is generated by the UE 702 (802, 902, 1002) (e.g., at 708) may be transmitted to and received by the base station 704 (804, 904, 1004) from the UE 702 (802, 902, 1002), for application of a precoder included in the CSI report 710. The UE 702 (802, 902, 1002) may generate (at 708) a prediction of channel status that may be based on a measurement(s) of a CSI-RS over a measurement window (Wmeas) that may begin at a CSI trigger, and the UE 702 (802, 902, 1002) may generate the CSI report 710 (908) to include the CSI. In such a configuration, the CSI may include the prediction of the channel status, and the CSI report 710 (908) may include the measurement(s) of the CSI-RS over the measurement window (Wmeas). That is, the CSI may include the prediction of the channel status at the UE 702 (802, 902, 1002), e.g., by the UE 702 (802, 902, 1002), and the CSI report 710 (908) may include the measurement(s) of the CSI-RS over the measurement window at the UE 702 (802, 902, 1002). In aspects, the window size may be included in the CSI report 710 (908) as a parameter in PMI information. In aspects, the generation of the CSI report 710 may be associated with a processing delay at the UE 702 (802, 902, 1002). The base station 704 (804, 904, 1004) may apply (at 712) the reported precoder, e.g., for codebook refinement, based on the CSI report, which may correspond to a velocity experienced by the UE that is greater than or equal to a velocity threshold, e.g., for high Doppler CSI. In aspects, the application of the precoder (e.g., at 712) may be associated with an application delay at the base station 704 (804, 904, 1004). Subsequent to application of the precoder (at 712), communications 714 with a precoding (e.g., as applied) that may be based on the CSI report (which may include the CSI for the codebook refinement) may be transmitted by the base station 704 (804, 904, 1004) and received by the UE 702 (802, 902, 1002). The UE 702 (802, 902, 1002) may thus receive, from the network entity, at the offset (L) from the start location and during the time window that has the window size (N4), the communications 714 with the applied precoding that may be based on the CSI report 710 that may include the CSI for the codebook refinement. The communications 714 may be transmitted by the base station 704 (804, 904, 1004) and received by the UE 702 (802, 902, 1002) beginning at the offset (L) from the start location and during the time window that has the window size (N4). In aspects, the communications 714 may be via PDSCH, and/or the like.

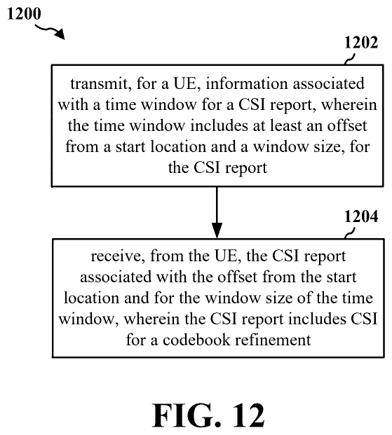

FIG. 12 is a flowchart 1200 of a method of wireless communication, in accordance with various aspects of the present disclosure. The method may be performed by a network entity or base station (e.g., the base station 102; the base station 704, 804, 904, 1004; the network entity 1302). At 1202, the network entity transmits, for a UE, information associated with a time window for a CSI report, where the time window includes at least an offset from a start location and a window size, for the CSI report. In some aspects, 1202 may be performed by the component 199.

For example, referring to FIGS. 6-10, to a network node (e.g., the base station 704 (804, 904, 1004)) may transmit, with reception by the UE 702 (802, 902, 1002), information 706 (805, 806, 808, 810, 812, 814, 816, 906, 910, 912, 1006) associated with a time window for a CSI report 710 to be transmitted by the UE 702 (802, 902, 1002). In aspects, the information 706 (906, 910) may include information associated with the offset (L) from the start location and/or the window size (N4) from which the offset (L) and/or the window size (N4) may be identified, derived, calculated, and/or the like, for configuration thereof, while in other aspects, the information 706 (805, 806, 808, 810, 812, 814, 816, 912, 1006) may include values, e.g., via configuration, for the offset (L) from the start location and/or the window size (N4). In aspects, the information 706 (805, 806, 808, 810, 812, 814, 816, 906, 910, 912, 1006) received by the UE 702 (802, 902, 1002) and transmitted by the base station 704 (804, 904, 1004) may be, without limitation, communicated via RRC, MAC-CE, DCI, and/or the like, for configuration of the CSI report 710. In aspects, information 706 (805, 806, 808, 810, 812, 814, 816) may be received by the UE 702 (802) and transmitted by the base station 704 (804) as one or more communications that may be jointly, or separately (e.g., hierarchically with down-selection), communicated to/at the UE 702 (802). In aspects, the information 706 (805, 806, 808, 810, 812, 814, 816) may include, without limitation, an offset (e.g., L) from a start location and/or a window size (N4), associated with the time window for the CSI report 710, to be configured. In aspects, receiving the information 706 (805, 806) may include receiving the offset (L) from the start location and the window size (N4) separately via RRC transmitted by the base station 704 (804). In aspects, receiving the information 706 (810, 812) may include receiving an RRC configuration of multiple offset-window size pairs, and receiving, in a MAC-CE or a DCI, an indication of an offset-window size pair, from the multiple offset-window size pairs in the RRC configuration, to be the offset and the window size. In aspects, receiving the information 706 (814, 816) may include receiving an RRC configuration of multiple offset values (L) and a window size (N4) value, and receiving, in a MAC-CE or a DCI, an indication of an offset value (L), from the multiple offset values in the RRC configuration, to be the offset (L) along with previously-configured the window size (N4). In aspects, the offset from the start location may correspond to a relative slot level offset to a DL trigger, a CSI reference slot, or a CSI report slot (CSI trigger, n_{ref}, or n).

In aspects, the information 706 (906, 910, 912, 1006) may include information associated with the offset (L) from the start location and/or the window size (N4) from which the offset (L) and/or the window size (N4) may be identified, derived, calculated, and/or the like, for configuration thereof. For example, the association between the window size (N4) and the pilot length (NCSI, d) may be a linear association that may be based on a product of the number of receptions of the CSI-RS at the UE and a linear parameter (a) that may be defined or that may be provided as part of the information 706, or may be a tabulated association in which the window size (N4) may correspond to a range of the number of receptions of the CSI-RS at the UE. In aspects, the information 706 (906) may include a minimal value and/or a maximal value of the window size (N4), and the CSI report 710 may include the window size (N4) that is based on a measurement(s) of a CSI-RS over a measurement window (e.g., a distance d or size Wmeas as in FIG. 6) at the UE 702 (902), e.g., for configuration of the window size (N4). In aspects, the information 706 (1006) may include an index value for a set of parameter combinations that may each include an associated window size (N4) and a frequency parameter(s). In such aspects, the associated window size (N4) of the parameter combination of the set of parameter combinations that correspond to the index value may be selected as the window size (N4) by the UE 702 (1002). In aspects, each parameter combination of the set of parameter combinations may also include a time domain basis parameter that corresponds to a respective associated window size (N4).

At 1204, the network entity receives, from the UE, the CSI report associated with the offset from the start location and for the window size of the time window, where the CSI report includes CSI for a codebook refinement. In some aspects, 1204 may be performed by the component 199.

For example, referring to FIGS. 6-10, in one configuration, the UE 702 (802, 902, 1002) may generate (at 708) a prediction of channel status that may be based on a measurement(s) of a CSI-RS over a measurement window (Wmeas) that may begin at a CSI trigger, and the UE 702 (802, 902, 1002) may generate the CSI report 710 (908) to include the CSI. In such a configuration, the CSI may include the prediction of the channel status, and the CSI report 710 (908) may include the measurement(s) of the CSI-RS over the measurement window (Wmeas). That is, the CSI may include the prediction of the channel status at the UE 702 (802, 902, 1002), e.g., by the UE 702 (802, 902, 1002), and the CSI report 710 (908) may include the measurement(s) of the CSI-RS over the measurement window at the UE 702 (802, 902, 1002). In aspects, the window size may be included in the CSI report 710 (908) as a parameter in PMI information. In aspects, the generation of the CSI report 710 may be associated with a processing delay at the UE 702 (802, 902, 1002). The CSI report 710 that is generated by the UE (e.g., at 708) may be transmitted to the base station 704 (804, 904, 1004), for application of a precoder included in the CSI report 710. The base station 704 (804, 904, 1004) may apply (at 712) the reported precoder, e.g., for codebook refinement, based on the CSI report, which may correspond to a velocity experienced by the UE that is greater than or equal to a velocity threshold, e.g., for high Doppler CSI. In aspects, the application of the precoder (e.g., at 712) may be associated with an application delay at the base station 704 (804, 904, 1004). Subsequent to application of the precoder (at 712), communications 714 with a precoding (e.g., as applied) that may be based on the CSI report (which may include the CSI for the codebook refinement) may be transmitted by the base station 704 (804, 904, 1004) and received by the UE 702 (802, 902, 1002). The UE 702 (802, 902, 1002) may thus receive, from the network entity (e.g., the base station 704 (804, 904, 1004)), at the offset (L) from the start location and during the time window that has the window size (N4), the communications 714 with the applied precoding by the base station 704 (804, 904, 1004) that may be based on the CSI report 710 that may include the CSI for the codebook refinement. The communications 714 may be transmitted by the base station 704 (804, 904, 1004) and received by the UE 702 (802, 902, 1002) beginning at the offset (L) from the start location and during the time window that has the window size (N4). In aspects, the communications 714 may be via PDSCH, and/or the like.

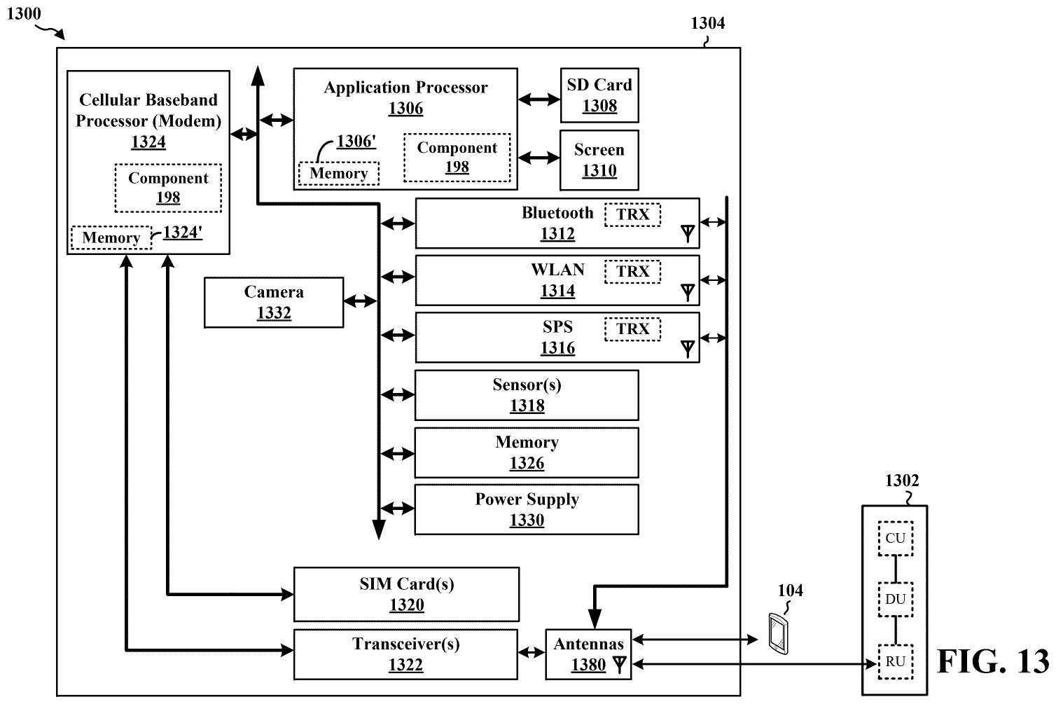

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

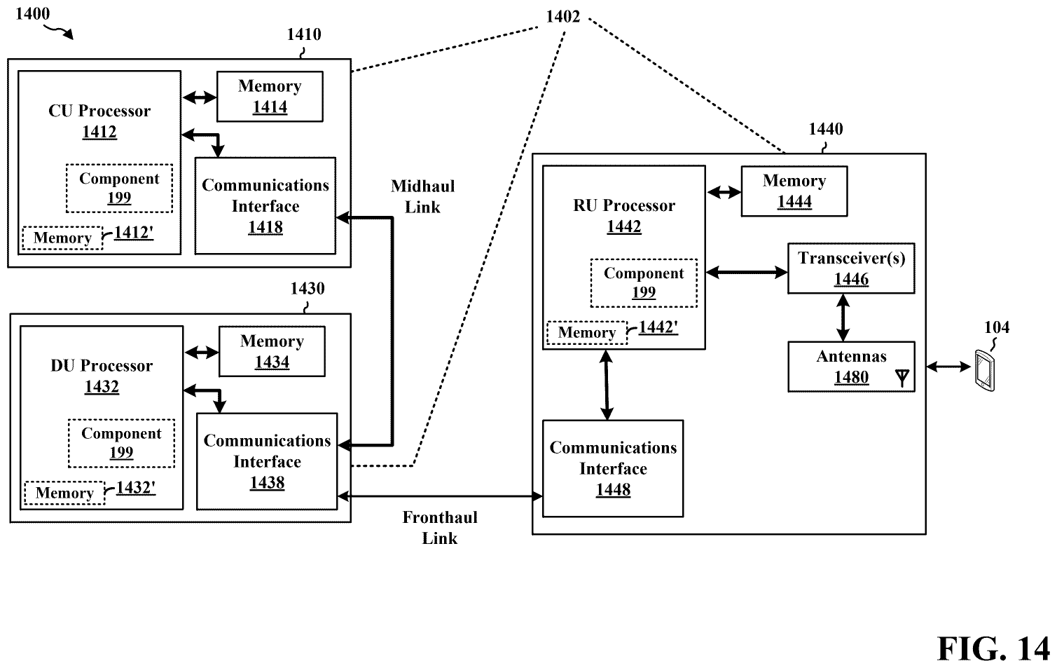

As discussed supra, the component 198 is configured to receive, from a network entity, information associated with a time window for a channel status information (CSI) report, where the time window includes at least an offset from a start location and a window size, for the CSI report. The component 198 is also configured to transmit, to the network entity, the CSI report associated with the offset from the start location and for the window size of the time window, where the CSI report includes CSI for a codebook refinement. The component 198, to receive the information, may be configured to receive an RRC configuration of multiple offset-window size pairs, and to receive, in the MAC-CE or the DCI, an indication of an offset-window size pair, from the multiple offset-window size pairs in the RRC configuration, to be the offset and the window size. The component 198, to receive the information, may be configured to receive an RRC configuration of multiple offsets and the window size, and to receive, in the MAC-CE or the DCI, an offset indication, from the multiple offsets in the RRC configuration, to be the offset. The component 198 may be configured to receive, from the network entity, at the offset from the start location and during the time window that has the window size, communications with a precoding that is based on the CSI report that includes the CSI for the codebook refinement. The component 198 may be further configured to perform any of the aspects described in connection with FIGS. 13, 14, and/or performed by the UE in FIGS. 5, 6, 7, 8, 9, 10. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for receiving, from a network entity, information associated with a time window for a channel status information (CSI) report, where the time window includes at least an offset from a start location and a window size, for the CSI report. In the configuration, the apparatus 1304, and in particular the cellular baseband processor 1324 and/or the application processor 1306, may also include means for transmitting, to the network entity, the CSI report associated with the offset from the start location and for the window size of the time window, where the CSI report includes CSI for a codebook refinement. The application processor 1306 may include means for receiving an RRC configuration of multiple offset-window size pairs, and means for receiving, in the MAC-CE or the DCI, an indication of an offset-window size pair, from the multiple offset-window size pairs in the RRC configuration, to be the offset and the window size. The application processor 1306 may include means for receiving an RRC configuration of multiple offsets and the window size, and means for receiving, in the MAC-CE or the DCI, an offset indication, from the multiple offsets in the RRC configuration, to be the offset. The application processor 1306 may include means for receiving, from the network entity, at the offset from the start location and during the time window that has the window size, communications with a precoding that is based on the CSI report that includes the CSI for the codebook refinement. The application processor 1306 may further include means for performing any of the aspects described in connection with FIGS. 13, 14, and/or performed by the UE in FIGS. 5, 6, 7, 8, 9, 10. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to transmit, for a user equipment (UE), information associated with a time window for a channel status information (CSI) report, where the time window includes at least an offset from a start location and a window size, for the CSI report. The component 199 is also configured to receive, from the UE, the CSI report associated with the offset from the start location and for the window size of the time window, where the CSI report includes CSI for a codebook refinement. The component 199, to transmit the information, may also be configured to transmit an RRC configuration of multiple offset-window size pairs, and to transmit, in the MAC-CE or the DCI, an indication of an offset-window size pair, from the multiple offset-window size pairs in the RRC configuration, to be the offset and the window size. The component 199, to transmit the information, may also be configured to transmit an RRC configuration of multiple offsets and the window size, and to transmit, in the MAC-CE or the DCI, an offset indication, from the multiple offsets in the RRC configuration, to be the offset. The component 199 may also be configured to transmit, for the UE, at the offset from the start location and during the time window that has the window size, communications with a precoding that is based on the CSI report that includes the CSI for the codebook refinement. The component 199 may be further configured to perform any of the aspects described in connection with FIGS. 13, 14, and/or performed by the UE in FIGS. 5, 6, 7, 8, 9, 10. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 includes means for transmitting, for a user equipment (UE), information associated with a time window for a channel status information (CSI) report, where the time window includes at least an offset from a start location and a window size, for the CSI report. In the configuration, the network entity 1402 includes means for receiving, from the UE, the CSI report associated with the offset from the start location and for the window size of the time window, where the CSI report includes CSI for a codebook refinement. The network entity 1402 may also include means for transmitting an RRC configuration of multiple offset-window size pairs, and means for transmitting, in the MAC-CE or the DCI, an indication of an offset-window size pair, from the multiple offset-window size pairs in the RRC configuration, to be the offset and the window size. The network entity 1402 may also include means for transmitting an RRC configuration of multiple offsets and the window size, and means for transmitting, in the MAC-CE or the DCI, an offset indication, from the multiple offsets in the RRC configuration, to be the offset. The network entity 1402 may also include means for transmitting, for the UE, at the offset from the start location and during the time window that has the window size, communications with a precoding that is based on the CSI report that includes the CSI for the codebook refinement. The network entity 1402 may include means for performing any of the aspects described in connection with FIGS. 13, 14, and/or performed by the network entity (e.g., base station) in FIGS. 5, 6, 7, 8, 9, 10. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

Some types of wireless communications (e.g., 5G NR) may be designed to enable CSI reporting, but utilize CSI configurations that limit scheduling flexibility generally and also for UE mobility considerations. Relatedly, information at the UE side for CSI reporting may be underutilized, which may have impacts on resources at both the network- and UE-sides. Aspects presented herein may provide enhancements to support improved CSI reporting. Aspects presented herein may include, without limitation, configurations for start offsets (L) and CSI window sizes (N4) that provide scheduling flexibility, utilize UE-side measurements, and account for UE mobility, such as medium-/high-velocity (e.g., Type-II Doppler), which enables specific codebook refinements by network entities. Additionally, the aspects presented provide for higher data rates, higher capacity, and higher spectral efficiency for CSI reporting and measurements, including UE-side measurements and determinations for CSI reporting configurations, as well as configurations for reduced lengths of reporting windows through flexible/adaptable window sizes (N4). For instance, a UE may receive information associated with a time window (e.g., having an offset (L) from a start location and a window size (N4)) for a CSI report from a network entity. The received information may be for, or be related to, configuring of the offset (L) from the start location and/or configuring of the window size (N4) for the CSI report. The described aspects enable the UE to transmit CSI for a codebook refinement in the CSI report, where the CSI report is associated with the offset (L) from the start location and is for the window size (N4) of the time window.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is method of wireless communication at a user equipment (UE), including: receiving, from a network entity, information associated with a time window for a channel status information (CSI) report, where the time window includes at least an offset from a start location and a window size, for the CSI report; and transmitting, to the network entity, the CSI report associated with the offset from the start location and for the window size of the time window, where the CSI report includes CSI for a codebook refinement.

Aspect 2 is the method of aspect 1, where the information is received via at least one of radio resource control (RRC), a medium access control (MAC) control element (MAC-CE), or downlink (DL) control information (DCI), and where the information includes the offset from the start location and the window size.

Aspect 3 is the method of aspect 2, where the offset from the start location corresponds to a relative slot level offset to a DL trigger, a CSI reference slot, or a CSI report slot.

Aspect 4 is the method of aspects 2 and 3, where receiving the information includes: receiving an RRC configuration of multiple offset-window size pairs; and receiving, in the MAC-CE or the DCI, an indication of an offset-window size pair, from the multiple offset-window size pairs in the RRC configuration, to be the offset and the window size.

Aspect 5 is the method of aspects 2 and 3, where the offset from the start location and the window size are separately received via RRC.

Aspect 6 is the method of aspects 2 and 3, where receiving the information includes: receiving an RRC configuration of multiple offsets and the window size; and receiving, in the MAC-CE or the DCI, an offset indication, from the multiple offsets in the RRC configuration, to be the offset.

Aspect 7 is the method of aspect 1, where the information includes at least one of a minimal value or a maximal value of the window size, and where the CSI report includes the window size that is based on at least one measurement of a CSI reference signal (CSI-RS) over a measurement window at the UE.

Aspect 8 is the method of aspects 1 and 7, where the window size is included in the CSI report as a parameter in precoding matrix indicator (PMI) information.

Aspect 9 is the method of aspect 1, where the window size is associated with a pilot length, where the pilot length corresponds to a number of receptions of a CSI reference signal (CSI-RS) at the UE.

Aspect 10 is the method of aspects 1 and 9, where the association between the window size and the pilot length is at least one of: a linear association based on a product of the number of receptions of the CSI-RS at the UE and a linear parameter that is defined or that is provided as a part of the information; or a tabulated association in which the window size corresponds to a range of the number of receptions of the CSI-RS at the UE.

Aspect 11 is the method of aspect 1, where the information includes an index value for a set of parameter combinations, where each parameter combination of the set of parameter combinations includes an associated window size and at least one frequency parameter, and where the associated window size of a corresponding parameter combination of the set of parameter combinations that corresponds to the index value is selected as the window size.

Aspect 12 is the method of aspects 1 and 11, where each parameter combination of the set of parameter combinations also includes a time domain basis parameter that corresponds to a respective associated window size.

Aspect 13 is the method of any of aspects 1 to 12, where the CSI includes a prediction of the channel status at the UE and the CSI report includes at least one measurement of a CSI reference signal (CSI-RS) over a measurement window at the UE.

Aspect 14 is the method of any of aspects 1 to 13, where the method further includes: receiving, via at least one transceiver of the UE and from the network entity, at the offset from the start location and during the time window that has the window size, communications with a precoding that is based on the CSI report that includes the CSI for the codebook refinement.

Aspect 15 is method of wireless communication at a network entity, that includes transmitting, for a user equipment (UE), information associated with a time window for a channel status information (CSI) report, where the time window includes at least an offset from a start location and a window size, for the CSI report; and receiving, from the UE, the CSI report associated with the offset from the start location and for the window size of the time window, where the CSI report includes CSI for a codebook refinement.

Aspect 16 is the method of aspect 15, where the information is transmitted via at least one of radio resource control (RRC), a medium access control (MAC) control element (MAC-CE), or downlink (DL) control information (DCI), and where the information includes the offset from the start location and the window size.

Aspect 17 is the method of aspect 16, where the offset from the start location corresponds to a relative slot level offset to a DL trigger, a CSI reference slot, or a CSI report slot.

Aspect 18 is the method of aspects 16 and 17, where transmitting the information includes: transmitting an RRC configuration of multiple offset-window size pairs; and transmitting, in the MAC-CE or the DCI, an indication of an offset-window size pair, from the multiple offset-window size pairs in the RRC configuration, to be the offset and the window size.

Aspect 19 is the method of aspects 16 and 17, where the offset from the start location and the window size are separately transmitted via RRC.

Aspect 20 is the method of aspects 16 and 17, where transmitting the information includes: transmitting an RRC configuration of multiple offsets and the window size; and transmitting, in the MAC-CE or the DCI, an offset indication, from the multiple offsets in the RRC configuration, to be the offset.

Aspect 21 is the method of aspect 15, where the information includes at least one of a minimal value or a maximal value of the window size, and where the CSI report includes the window size that is based on at least one measurement of a CSI reference signal (CSI-RS) over a measurement window at the UE.

Aspect 22 is the method of aspects 15 and 21, where the window size is included in the CSI report as a parameter in precoding matrix indicator (PMI) information.

Aspect 23 is the method of aspect 15, where the window size is associated with a pilot length, where the pilot length corresponds to a number of receptions of a CSI reference signal (CSI-RS) at the UE.

Aspect 24 is the method of aspects 15 and 23, where the association between the window size and the pilot length is at least one of: a linear association based on a product of the number of receptions of the CSI-RS at the UE and a linear parameter that is defined or that is provided as a part of the information; or a tabulated association in which the window size corresponds to a range of the number of receptions of the CSI-RS at the UE.

Aspect 25 is the method of aspect 15, where the information includes an index value for a set of parameter combinations, where each parameter combination of the set of parameter combinations includes an associated window size and at least one frequency parameter, and where the associated window size of the parameter combination of the set of parameter combinations that corresponds to the index value is selected as the window size.

Aspect 26 is the method of aspects 15 and 25, where each parameter combination of the set of parameter combinations also includes a time domain basis parameter that corresponds to a respective associated window size.

Aspect 27 is the method of any of aspects 15 to 26, where the CSI includes a prediction of the channel status at the UE and the CSI report includes at least one measurement of a CSI reference signal (CSI-RS) over a measurement window at the UE.

Aspect 28 is the method of any of aspects 15 to 27, where the method further includes: transmitting, via at least one of an antenna or a transceiver of the network entity and for the UE, at the offset from the start location and during the time window that has the window size, communications with a precoding that is based on the CSI report that includes the CSI for the codebook refinement.

Aspect 29 is a method of wireless communication for implementing any of aspects 1 to 28.

Aspect 30 is an apparatus for wireless communication including means for implementing any of aspects 1 to 28.

Aspect 31 is a computer-readable medium (e.g., a non-transitory computer-readable medium) storing computer executable code, the code when executed by at least one processor causes the at least one processor to implement any of aspects 1 to 28.

1. An apparatus for wireless communication at a user equipment (UE), comprising:
a memory; and
at least one processor coupled to the memory and, based at least in part on stored information that is stored in the memory, the at least one processor is configured to:
receive, from a network entity, information associated with a time window for a channel status information (CSI) report, wherein the time window includes at least an offset from a start location and a window size, for the CSI report; and
transmit, to the network entity, the CSI report associated with the offset from the start location and for the window size of the time window, wherein the CSI report includes CSI for a codebook refinement.

2. The apparatus of claim 1, wherein the information is received via at least one of radio resource control (RRC), a medium access control (MAC) control element (MAC-CE), or downlink (DL) control information (DCI):
wherein the information includes the offset from the start location and the window size.

3. The apparatus of claim 2, wherein the offset from the start location corresponds to a relative slot level offset to a DL trigger, a CSI reference slot, or a CSI report slot.

4. The apparatus of claim 2, wherein to receive the information, the at least one processor is configured to:
receive an RRC configuration of multiple offset-window size pairs; and
receive, in the MAC-CE or the DCI, an indication of an offset-window size pair, from the multiple offset-window size pairs in the RRC configuration, to be the offset and the window size.

5. The apparatus of claim 2, wherein the offset from the start location and the window size are separately received via the RRC.

6. The apparatus of claim 2, wherein to receive the information, the at least one processor is configured to:
receive an RRC configuration of multiple offsets and the window size; and
receive, in the MAC-CE or the DCI, an offset indication, from the multiple offsets in the RRC configuration, to be the offset.

7. The apparatus of claim 1, wherein the information includes at least one of a minimal value or a maximal value of the window size, and wherein the CSI report includes the window size that is based on at least one measurement of a CSI reference signal (CSI-RS) over a measurement window at the UE.

8. The apparatus of claim 7, wherein the window size is included in the CSI report as a parameter in precoding matrix indicator (PMI) information.

9. The apparatus of claim 1, wherein the window size is associated with a pilot length, wherein the pilot length corresponds to a number of receptions of a CSI reference signal (CSI-RS) at the UE.

10. The apparatus of claim 9, wherein an association between the window size and the pilot length is at least one of:
a linear association based on a product of the number of receptions of the CSI-RS at the UE and a linear parameter that is defined or that is provided as a part of the information: or
a tabulated association in which the window size corresponds to a range of the number of receptions of the CSI-RS at the UE.

11. The apparatus of claim 1, wherein the information includes an index value for a set of parameter combinations, wherein each parameter combination of the set of parameter combinations includes an associated window size and at least one frequency parameter, and wherein the associated window size of a corresponding parameter combination of the set of parameter combinations that corresponds to the index value is selected as the window size.

12. The apparatus of claim 11, wherein each parameter combination of the set of parameter combinations also includes a time domain basis parameter that corresponds to a respective associated window size.

13. The apparatus of claim 1, wherein the CSI includes a prediction of a channel status at the UE and the CSI report includes at least one measurement of a CSI reference signal (CSI-RS) over a measurement window at the UE.

14. The apparatus of claim 1, wherein the at least one processor is further configured to:
receive, from the network entity, at the offset from the start location and during the time window that has the window size, communications with a precoding that is based on the CSI report that includes the CSI for the codebook refinement.

15. An apparatus for wireless communication at a network node, comprising:
a memory; and
at least one processor coupled to the memory and, based at least in part on stored information that is stored in the memory, the at least one processor is configured to:
transmit, for a user equipment (UE), information associated with a time window for a channel status information (CSI) report, wherein the time window includes at least an offset from a start location and a window size, for the CSI report; and
receive, from the UE, the CSI report associated with the offset from the start location and for the window size of the time window, wherein the CSI report includes CSI for a codebook refinement.

16. The apparatus of claim 15, wherein the information is transmitted via at least one of radio resource control (RRC), a medium access control (MAC) control element (MAC-CE), or downlink (DL) control information (DCI):
wherein the information includes the offset from the start location and the window size.

17. The apparatus of claim 16, wherein the offset from the start location corresponds to a relative slot level offset to a DL trigger, a CSI reference slot, or a CSI report slot.

18. The apparatus of claim 16, wherein to transmit the information, the at least one processor is configured to:
transmit an RRC configuration of multiple offset-window size pairs; and
transmit, in the MAC-CE or the DCI, an indication of an offset-window size pair, from the multiple offset-window size pairs in the RRC configuration, to be the offset and the window size.

19. The apparatus of claim 16, wherein the offset from the start location and the window size are separately transmitted via the RRC.

20-28. (canceled)

29. A method of wireless communication at a user equipment (UE), comprising:
receiving, from a network entity, information associated with a time window for a channel status information (CSI) report, wherein the time window includes at least an offset from a start location and a window size, for the CSI report; and
transmitting, to the network entity, the CSI report associated with the offset from the start location and for the window size of the time window, wherein the CSI report includes CSI for a codebook refinement.

30. (canceled)
